(19) United States
(12) Patent Application Publication
(10) Pub. No.: US 2004/0100512 A1
(43) Pub. Date: May 27, 2004

(54) Method and apparatus for printing on rigid panels and other contoured, textured or thick substrates

(75) Inventor: Richard N. Codos, Warren, NJ (US)

Correspondence Address: WOOD, HERRON & EVANS, L.L.P., 2700 Carew Tower, 441 Vine St., Cincinnati, OH, 45202, US

(73) Assignee: L&P Property Management Company

(21) Appl. No.: 10/716,724

(22) Filed: Nov. 19, 2003

Related U.S. Application Data
(63) Continuation of application No. 09/989,006, filed on Nov. 21, 2001.
Application No. 09/989,006 is a continuation-in-part of application No. PCT/US01/27023, filed on Aug. 30, 2001.
Application No. PCT/US01/27023 is a continuation-in-part of application No. 09/822,795, filed on Mar. 30, 2001, now Pat. No. 6,523,921.
Application No. 09/822,795 is a continuation-in-part of application No. 09/650,596, filed on Aug. 30, 2000, now abandoned.

(51) Int. Cl. B41J 25/308

(52) U.S. Cl. 347/8

(57) ABSTRACT

Ink jet printing is provided onto rigid panels such as office partitions, which have surfaces that are contoured, textured or made of a fabric or other three-dimensional material, or are otherwise differently spaced from the plane of the panel such that the distance between a printing element and the point on the surface on which ink is to be deposited is not always the same or exactly predictable. Preferably, fabric covered panels are printed using ink jet printing, preferably using ultraviolet (UV) light curable ink, which is first, at least partially cured with UV light and then subjected to heating to more completely cure and dry the ink to remove, by evaporation or otherwise, the uncured monomers. The panel surface may be contoured by quilting or molding processes. Print head to panel spacing is adjustable to maintain a predetermined constant distance from the printing element to the surface of the panel where the ink is to be applied. A contact sensor such as a rolling element or a non-contact sensor such as a laser or other optical element may be used to produce a measurement, in response to which the spacing is adjusted. Alternatively, an initial measurement can be made and the contour of the surface followed by programmed control. A textured surface may be followed to within a millimeter, more or less, to optimize ink jetting distance. The position or focal length of the UV light curing head may also be varied to maintain focus of the UV light on the ink on a contoured surface of the substrate.

This application claims the benefit of, and is a Continuation of, each of the prior applications: Ser. No. 09/989,006, filed Nov. 21, 2001, which is a Continuation-In-Part of: Serial No. PCT/US01/27023, filed on Aug. 30, 2001, which is a Continuation-in-Part of: Ser. No. 09/822,795, filed Mar. 30, 2001, which is a Continuation-in-part of: Ser. No. 09/650,596, filed Aug. 30, 2000, all hereby expressly incorporated by reference herein.

### FIELD OF THE INVENTION

The present invention relates to printing on fabric or other materials of which the depth, texture, contour or other third-dimensional feature or property of the material affects the printing process. The invention is further related to the printing onto such materials as are used in quilting, fabric or other material covered rigid panels such as office partitions and other printing processes in which the positioning of a printing element relative to the surface is an issue. The invention is particularly relevant to the ink jet printing onto such materials and to printing with ultra-violet light (UV) curable inks.

### BACKGROUND OF THE INVENTION

Quilting is an art in which patterns are stitched through a plurality of layers of material. The quilting has the functional effects of joining layers of material together and of producing a pillowed product that is useful for mattress covers, comforters and cold weather clothing. Quilting also has an ornamental aspect in producing such products with sewn designs or patterns. The ornamental qualities of the products can also be enhanced with the use of printing to supplement the stitched patterns, either before or after the quilting is applied. Whether the quilting or the printing is applied first, the second process requires a registration of the second applied pattern to the first.

Were a quilted product to be quilted first and then a printed design thereafter applied, it would be necessary to conform the printing to the three-dimensional pillowed surface of the quilt. This would make it very difficult to apply a printed design to a quilted product in an automated or commercially practical fashion. The use of newer printing methods, such as ink jet printing, to apply such patterns to previously quilted substrates has not been attempted for this reason.

In printing onto fabric facing layers, prior to the sewing of a quilted pattern on the material, and in the printing onto fabric in general for any other purpose, the three-dimensional textured surface of the fabric, as well as the three-dimensional wicking property of the fabric, has made printing onto fabric of limited utility in the prior art. Ink jet printing at high production rates in particular has been applied with limited success onto fabrics.

In ink jet printing, two main categories of inks are used, solvent based inks and inks formulated to be cured by UV or ultraviolet light. Solvent based inks include either water or organic based solvents. Solvent based inks are cured by evaporation of the solvents. Some solvent based inks cure only by air drying, but many require the application of heat to enhance the evaporation of the solvent and, in some cases, to facilitate a chemical change or polymerization of the ink. UV curable inks include monomers that polymerize when exposed to ultraviolet light at some threshold energy level.

Some heat curable or air curable inks that are organic solvent based or water based inks do not have as high a color intensity as UV curable inks might have because the pigments or dyes that produce the color are somewhat diluted by the solvent. Furthermore, organic solvents can produce an occupational hazard, requiring that costly measures be taken to minimize contact of workers to the evaporating solvents and to minimize other risks such as the risk of fire. Solvent based inks also tend to dry out and, when applied by ink jet processes, tend to eventually clog ink jet nozzles.

UV curable inks are capable of providing high color intensity and do not present the hazards that many solvent based inks present. Printing with UV curable ink on fabric, however, presents other problems that have not been solved in the prior art. To cure UV ink, it must be possible to precisely focus a UV curing light onto the ink. UV ink, when jetted onto fabric, particularly onto highly textured fabric, is distributed at various depths over the texture of the fabric surface. Furthermore, the ink tends to soak into, or wick into, the fabric. As a result, the ink is present at various depths on the fabric, so that some of the ink at depths above or below the focal plane of the UV curing light evade the light needed to cause a total cure of the ink. In order to cure, UV ink must be exposed to UV light at an energy level above a curing threshold. However, increasing the intensity of the curing light beyond certain levels in order to enhance cure of the ink can have destructive effects on the fabric.

UV curing of jetted ink on fabric has a limited cure depth that is determined by the depth of field of the focused curing UV light. Therefore, the UV light proceeds to cure only about 90%, or 97%, and can be even up to about 99% of the ink when deposited on fabric. However, even an order of magnitude of 0.01% of uncured jetted ink may be unacceptable for certain applications.

Further, ink jet printing can be carried out with different ink color dots applied in a side-by-side pattern or in a dot-on-dot (or drop-on-drop) pattern. The dot-on-dot method is capable of producing a higher color density, but the higher density dot-on-dot pattern is even more difficult to cure when the cure is by UV light.

In addition, UV ink can be applied quickly to reduce wicking and UV ink can be developed to allow minimized wicking. Some wicking, however, helps to remove artifacts. Further, inks developed to eliminate wicking leave a stiff paint-like layer on the surface of the fabric, giving the fabric a stiff feel or “bad hand”. Therefore, to reduce the UV curing problem by eliminating wicking is not desirable.

The applying of ink to fabric or to any textured, contoured or other three-dimensional surface by ink jet printing is limited due to the need to maintain a proper spacing between the ink jet nozzles and the surface on which the printing is applied. Normally, a distance of plus or minus one or two millimeters is necessary to maintain effective printing by an inkjet process. If the distance from the nozzles to the surface being printed is too great, deviations from ideal parallel paths of the drops from different nozzles become magnified. Further, the longer flight path of the drops from the print head to the substrate, the more dependent the accuracy of the printing becomes on the relative speed between the print head and the substrate, which limits the rate of change of such speed and direction changes. Also, drop velocity declines with distance from the nozzles and their paths become affected by air currents and other factors. Additionally, droplet shape changes with distance from the nozzle, which changes the effects of the drop on the substrate. Variations in the distance from the print head to the substrate causes irregular effects on the printed image.

In addition to problems in jetting ink onto contoured surfaces, the curing of UV inks that requires sharply focused UV energy to deliver sufficient curing energy to the ink is difficult to achieve where the surface is contoured.

Three-dimensional surfaces onto which such printing is desirable include quilted materials and material covered rigid panels such as office partitions. Such panels may have generally flat surfaces that are covered with textured material or an open material having a surface depth that causes the ink to travel a nonuniform distance from the nozzle or other source onto the material.

For the reasons stated above, printing has not been successful on fabric or other textured or contoured materials, particularly printing with UV curable inks and printing using ink jet processes, and accordingly,,a need exists for a process of doing so. There exists a particular need to print patterns onto mattress ticking and mattress cover quilts, as well as onto other types of fabrics, and other textured, contoured or three-dimensional substrates.

### SUMMARY OF THE INVENTION

An objective of the present invention is to provide for the printing onto three-dimensional substrates, particularly onto highly textured fabrics, tufted or irregular fabrics and other materials, or contoured surfaces such as quilts, mattress covers, molded or stamped rigid materials, and other such three-dimensional surfaces. It is a more particular objective of the invention to print onto such surfaces with ink jet processes and with UV curable inks.

According to the principles of the present invention, printed images are applied to three-dimensional substrates with printing elements that are maintained at a variable distance over the plane of the substrate and at a controlled and uniform spacing from the immediate area of the substrate on which the printing is being applied. In the preferred embodiment of the invention, the printing element is an ink jet print head, and spacing that is to be maintained is the distance from the ink discharge nozzle of the print head to the point on the substrate onto which the ink is to be jetted. To maintain this distance, one or more sensors are provided to measure the distance from the print head carriage to the point on the substrate on which ink is to be projected. The sensors generate a reference signal that is fed back to a servo control that maintains the adjustment of the distance from the print head nozzle to the substrate essentially constant or within a tolerance of a predetermined distance setting. While it is preferred to adjust the position of the print head or nozzle thereof relative to the substrate which is fixed on a printing machine frame, the substrate surface can alternatively be positioned relative to a print head that is maintained at a fixed vertical position on the frame.

Preferably, UV ink is printed onto material and the cure of the ink is initiated by exposure to UV light. With or following the exposure to the UV light, the printed fabric is subjected to heat, preferably by blowing heated air onto the material, which extends the UV light initiated curing process and removes uncured volatile components of the ink. With quilted bedding fabric materials, UV curable ink is jetted onto the fabric and the jetted ink is exposed to UV curing light to cure the ink preferably to about 90 to 97% polymerization, with the fabric bearing the partially cured, jetted ink then heated in a hot air blower curing oven at which the UV light initiated polymerization continues, uncured monomers are vaporized, or both, in order to produce a printed image of UV ink that contains a low quantity of uncured monomer or other ink components, for example less than 0.01%.

Where UV ink is jetted onto a highly textured fabric such as a mattress cover ticking material, the ink is jetted at a dot density of from about 180×254 dots per inch per color to about 300×300 dots per inch per color. For certain common UV inks, four colors of a CMYK color palette are applied, each in drops or dots of, for example, about 75 picoliters, or approximately 80 nanograms, per drop, utilizing a UV ink jet print head. A UV curing light head is provided, which moves either with the print head or independent of the print head and exposes the deposited drops of UV ink with a beam of about 300 watts per linear inch, applying about 1 joule per square centimeter, thereby producing at least a 90% UV cure. The fabric on which the jetted ink has been thereby partially UV cured is then passed through an oven where it is heated to about 300° F. for from about 30 seconds up to about three minutes. Forced hot air is preferably used to apply the heat in the oven, but other heating methods such as infrared or other radiant heaters may be used. Similar parameters may be used for cloth covered rigid panels such as office partitions.

When printing onto contoured material, the distance from the print heads to the substrate where the ink is to be deposited can be determined by measuring the distance from a sensor to the substrate ahead of the print heads and mapping the location of the surface. For bidirectional print heads that move transversely across the longitudinally advancing fabric, providing two distance measuring sensors, one on each of the opposite sides of the print heads, measures the distance to the contoured fabric surface when the print heads are moving in either direction. For some inks and for sufficiently rigid materials, a mechanical rolling sensor may be used, for example, by providing a pair of rollers, with one roller ahead of, and one head behind, the print head so that the average distance between the two rollers and a reference point on the print head can be used to control the distance of the print head from the plane of the substrate. To achieve this, one or more print heads can be mounted to a carriage having the rollers on the ends thereof so that the mechanical link between the rollers moves the print head relative to the plane of the substrate. In most cases, a non-contact sensor, such as a laser or photo eye sensor, is preferred in lieu of each roller. The outputs of two sensors on opposite sides of the print heads can be communicated to a processor, to measure the distance from the heads to the fabric ahead of the bidirectional heads, to drive a servo motor connected to the print head to raise and lower the head relative to the substrate plane so that the print heads move parallel to the contoured surface and jet ink onto the fabric across a fixed distance.

These and other objects of the present invention will be more readily apparent from the following detailed description of the preferred embodiments of the invention.

### BRIEF DESCRIPTION OF THE DRAWINGS

FIG. 1 is a perspective view of one embodiment of an apparatus embodying principles of the present invention in which ink jet printing is applied to panels of rigid office partitions that are covered with textured or contoured material or fabric.

FIG. 2 is a cross-sectional view along line 2-2 of FIG. 1 showing structure for maintaining print head to substrate distance where a substrate is more highly contoured.

FIG. 2A is a cross-sectional view similar to FIG. 2 showing alternative structure for maintaining print head to substrate distance.

### DETAILED DESCRIPTION OF THE PREFERRED EMBODIMENT

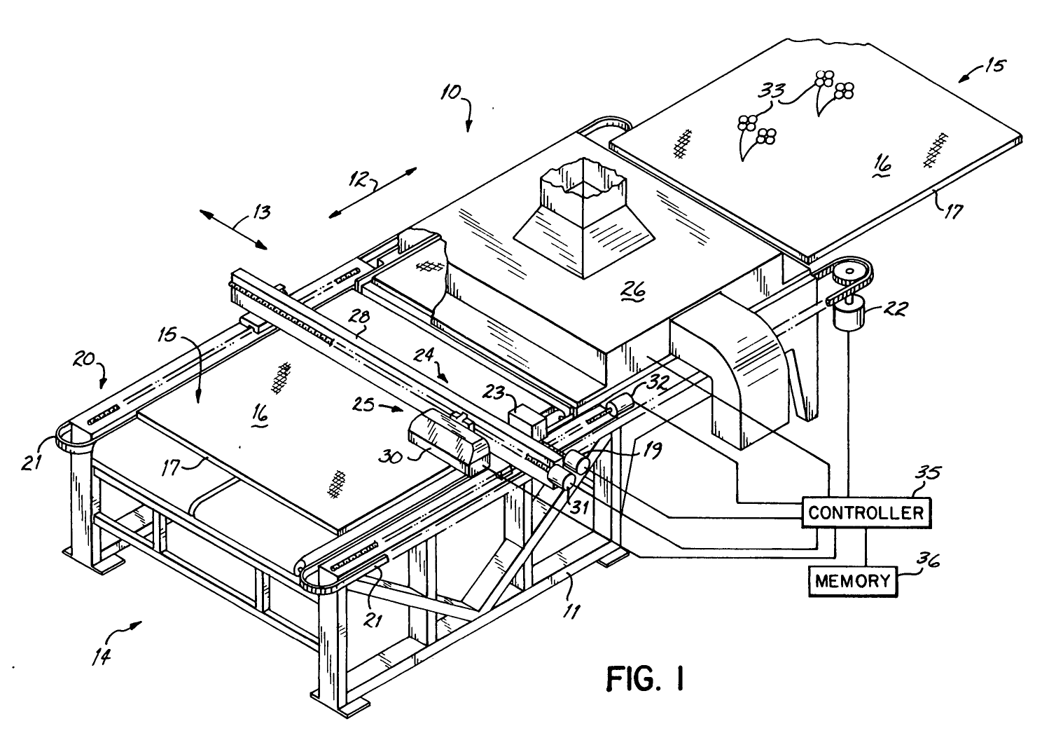

FIG. 1 illustrates a machine 10 for printing onto rigid panels. The machine 10 includes a stationary frame 11 with a longitudinal extent represented by an arrow 12 and a transverse extent represented by an arrow 13. The machine 10 has a front end 14 into which is advanced a rigid panel 15, such as that of which an office partition may be formed. The panel 15 may include a metal or wooden frame 17 on which is stretched a facing material 16, such as a textured fabric or molded foam. Panels 15 are carried longitudinally on the machine 10 by a conveyor or conveyor system 20, formed of a pair of opposed pin tentering belt sets 21 which extend through the machine 10 and onto which the panels 15 is fed at the front end 14 of the machine 10. The belt sets 21 retain the panels 15 in a precisely known longitudinal position on the belt sets 21 to carry the panels 15 through the longitudinal extent of the machine 10, preferably with an accuracy of ¼ inch. The longitudinal movement of the belts 21 of the conveyor 20 is controlled by a conveyor drive 22. The conveyor 20 may take alternative forms including, but not limited to, opposed cog-belt side securements, longitudinally moveable positive side clamps that engage the panels 15 or other securing structure for holding the panels 15 fixed relative to the conveyor 20.

Along the conveyor 20 are provided three stations, including an ink jet printing station 25, a UV light curing station 24, and a heated drying station 26. The printing station 25 includes an ink jet carriage having one or more ink jet printing heads 30 thereon. The carriage of the print heads 30 is shown as transversely moveable on the front of a cross bar 28 that extends transversely across the frame 11 and may, but not necessarily, also be longitudinally moveable on the frame 11 under the power of a transverse servo drive motor 31 and an optional longitudinal drive 32. Alternatively, the heads 30 may extend across the width of the web 15 and be configured to print an entire transverse line of selectable points simultaneously onto the panel 15.

The ink jet printing heads 30 are configured to jet UV ink, for example, at 75 picoliters, or approximately 80 nanograms, per drop, and may do so for each of four colors according to a CMYK color pallette. The dots are preferably dispensed at a resolution of about 180 dots per inch by about 254 dots per inch. The resolution may be higher or lower as desired, but the 180×254 resolution is preferred. If desirable for finer images or greater color saturation, 300×300 dots per inch is preferable. The drops of the different colors can be side-by-side or dot-on-dot. Dot-on-dot (sometimes referred to as drop-on-drop) produces higher density.

The print heads 30 are provided with controls that allow for the selective operation of the heads 30 to selectively print designs of one or more colors onto the surface of the panel 15. The drive 22 for the conveyor 20, the drives 31,32 for the print head 30 and the operation of the print heads 30 are program controlled to print patterns 33 at known locations on the panel 15 by a controller 35, which includes a memory 36 for storing programmed patterns, machine control programs and real time data regarding the nature and longitudinal and transverse location of printed designs 33 on the panel 15 and the relative longitudinal position of the panel 15 in the machine 10.

The UV curing station 24 includes a UV light curing head 23 that may move with the print heads 30 or, as is illustrated, move independently of the print heads 30. The UV light curing head 23 is configured to sharply focus a narrow, longitudinally extending beam of UV light onto the printed surface of the fabric. The UV curing head 23 is provided with a transverse drive 19 which is controlled to transversely scan the printed surface of the fabric to move the light beam across the fabric.

Preferably, the curing head 23 is intelligently controlled by the controller 35 to selectively operate and quickly move across areas having no printing and to scan only the printed images with UV light at a rate sufficiently slow to UV cure the ink, thereby avoiding wasting time and UV energy scanning unprinted areas. If the head 23 is included in the printing station 25 and is coupled to move with the print heads 30, UV curing light can be used in synchronism with the dispensing of the ink immediately following the dispensing of the ink.

The UV curing station 24, in the illustrated embodiment, is preferably located either immediately downstream of the printing station 25, or on the print head carriage to the sides of the print heads, so that the fabric, immediately following printing, is subjected to a UV light cure. In theory, one photon of UV light is required to cure one free radical of ink monomer so as to set the ink. In practice, one joule of UV light energy per square centimeter of printed surface area is supplied by the UV curing head 23. This is achieved by sweeping a UV beam across the printed area of the fabric at a power of 300 watts per linear inch of beam width. This is sufficient to produce a UV cure of at least 90%. Increasing the UV light power up to 600 watts per linear inch can be done to achieve a 97% or better cure. Alternatively, if fabric thickness and opacity are not too high, curing light can be projected from both sides of the fabric to enhance the curing of the UV ink. Using power much higher can result in the burning or even combustion of the fabric, so UV power has an upper practical limit.

The heat curing or drying station 26 may be fixed to the frame 11 downstream of the UV light curing station or may be located off-line. With 97% UV cure, the ink will be sufficiently colorfast so as to permit the drying station to be off-line. When on-line, the drying station should extend sufficiently along the length of fabric to adequately cure the printed ink at the rate that the fabric is printed. When located off-line, the heat curing station can operate at a different rate than the rate of printing. Heat cure at the oven or drying station 26 maintains the ink on the fabric at about 300° F. for up to three minutes. Heating of from 30 seconds to three minutes is the anticipated advantageous range. Heating by forced hot air is preferred, although other heat sources, such as infrared heaters, can be used as long as they adequately penetrate the fabric to the depth of the ink.

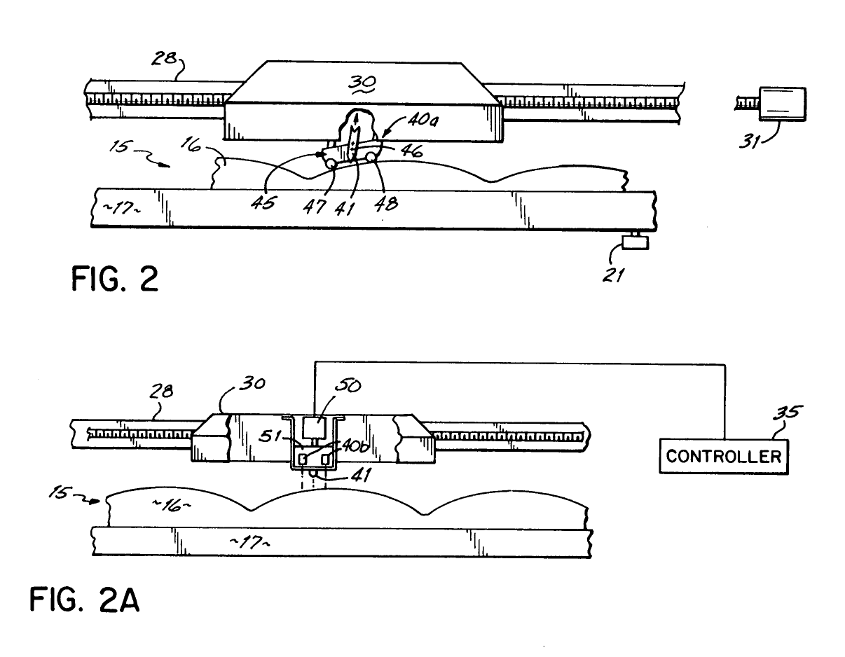

A quilting station may be located on-line with the printing station or off-line, and either before or after the printing station. Locating a quilting station downstream of the oven 26 is advantageous in the case of quilted comforters and mattress covers and where quilting is to be applied and registered with printing on the fabric. A single-needle quilting station may be used, such as is described in U.S. patent application Ser. No. 08/831,060, now U.S. Pat. No. 5,832,849, to Kaetterhenry et al. entitled “Web-fed Chain-stitch Single-needle Mattress Cover Quilter with Needle Deflection Compensation”, which is expressly incorporated by reference herein. Other suitable single-needle type quilting machines with which the present invention may be used are disclosed in U.S. patent application Ser. Nos. 08/497,727 and 08/687,225, now U.S. Pat. Nos. 5,640,916 and 5,685,250, respectively, both entitled “Quilting Method and Apparatus”, expressly incorporated by reference herein. Such a quilting station may also include a multi-needle quilting structure such as that disclosed in U.S. Pat. No. 5,154,130, also expressly incorporated by reference herein.

Where quilting, molding or other contouring of a substrate is carried out before the printing onto the substrate, registration of the printing to the pre-applied contouring will usually be desired. To register the printing to pre-applied contours, the location of the contour pattern can be calculated in relation to a reference point on the substrate that can be sensed by sensors at the printing station. The location of the pattern can be directly sensed with a sensor 40 mounted on the print head 30, as illustrated respectively as 40a, 40b in FIGS. 2 and 3. The print head 30 includes a nozzle or ink jet nozzle array 41 that is directed downward toward the upwardly facing surface 16 of a substrate such as the panel 15. The panel 15 may have, for example, depressions or channels 43 on its surface 16 that have been formed by stitching or molding, as illustrated in FIG. 2. The sensor 40 measures the distance from the nozzle 41 to the surface 16. Information from the sensor 40 can be communicated to the controller 35 and correlated with the longitudinal and transverse position information of the print head 30 and interpreted to determine the location of the contoured pattern so that the printed image can be applied to the surface 16 in registration with the pre-applied contour pattern.

In the embodiment of FIG. 2, the sensor 40 is a mechanical sensor 40a that includes a wheeled carriage 45. The nozzle 41 is mounted at the midpoint of the carriage 45, which is, in turn, pivotally connected to the print head 30 about a longitudinal axis 46 through the center of the carriage 45. The carriage has left and right sensing wheels 47, 48, respectively, that ride on the surface 16 of the panel 15 and follow the contour. The carriage 45 moves vertically relative to the print head 30 and follows the contour of the surface 16. The nozzle 41, being midway between the wheels 47, 48, will be positioned vertically at the average of the vertical positions of the wheels 47, 48. In this way, the nozzle 41 is passively positioned at a controlled distance relative to the surface 16 of the panel 15 in response to the detected location of the surface 16 of the panel 15 as determined by the carriage 45 as the wheels 47, 48 ride on the surface 16.

The distance between the UV head 23 and the fabric is preferably also controllable so that the curing light is always precisely focused onto the printed contoured surface of the fabric. This distance may controlled by mounting the UV curing head to move with the print heads, such as by communicating the UV light through optic fibers adjacent the print heads, for example, one fiber on each side of the print heads, or by mounting the UV curing head 23 on a separate carriage and providing it with a separate distance adjusting servo motor. Separate control of the UV curing head 23 can be in response to the sensors used to measure print head distance or in response to separate sensors provided to measure curing head distance. Where the print head sensors are used to control curing head to fabric distance, a memory can be used to store a map of the surface or portion of the surface while a controller retrieves the correct distance information from the memory that corresponds to the position of the curing head over the fabric. Alternatively, the UV curing head can be fixed and the focal length of the UV light from the source automatically varied.

Whether the panel 15 has a contoured pattern on its surface 16 or merely a textured material, print quality is maintained by maintaining precise spacing between the nozzle 41 and the surface 16 of the panel 15. FIG. 3 illustrates a rigid panel 15 having its outer upwardly facing surface 16 covered with a coarse woven or textured fabric. As the print head 30 moves transversely on the cross bar 28, the vertical position, relative to the print head 30, of the point on the surface 16 of the panel 15 at which the nozzle 41 is directed varies, often one or more millimeters. To measure such distance variations, an optical or laser sensor 40b is provided either on the print head 30 or on the carriage at a fixed height from the plane of support of the fabric. The sensor 40b instantaneously measures the distance from the nozzle 41 to the surface 16 of the panel 15 and communicates the measurement to the controller 35. The nozzle 41 is mounted on an output actuator 51 of a servo motor 50 mounted in the print head 30. The controller 35 sends a control signal to the servo motor 50 to move the nozzle 41 on the print head 30 vertically in response to the distance measurement from the sensor 40b to maintain a constant distance from the nozzle 41 to the surface 16 of the panel 15.

Printing on rigid panels, even where the surface is not textured or contoured, can benefit from the sensing and adjustment of the distance from print nozzle to surface of the panel since the rigid frame of the panel and the thickness of the panel when supported on the frame of a printing apparatus makes the position of the upper surface of the panel unpredictable.

The above description is representative of certain preferred embodiments of the invention. Those skilled in the art will appreciate that various changes and additions may be made to the embodiments described above without departing from the principles of the present invention. Therefore, the following is claimed:

1. A method of printing on substrate comprising the steps of:
moving a print head carriage, having at least one ink jet nozzle thereon, parallel to a plane in which is supported a substrate having a surface that is at a nonuniform location relative to said plane;
adjusting the distance from the nozzle to the plane to position the nozzle at a predetermined distance from the surface of the substrate where ink is to be jetted from the nozzle;
jetting ink from the nozzle across the predetermined distance onto the surface of a substrate.

2. The method of claim 1 wherein:
the ink is UV curable ink;
the method further comprises the step of at least partially curing the ink jetted onto the surface by exposing the jetted ink to ultraviolet light.

3. The method of claim 1 further comprising the steps of:
sensing the position of the surface of the substrate relative to the carriage; and
the adjusting of the distance from the nozzle to the plane is performed in response to said sensing.

4. The method of claim 1 wherein:
the sensing of the positions is carried out while moving the print head carriage; and
the adjusting includes varying the position of the nozzle relative to the plane as the print head carriage moves so as to maintain the predetermined distance across the substrate in response to the sensed distance.

5. A method of printing on rigid panels comprising the steps of:
moving parallel to a rigid panel a print head carriage having an ink jet nozzle thereon directed toward a surface of the panel;
automatically adjusting the distance of the nozzle from the panel to maintain a predetermined distance between the nozzle and the surface of the panel at the location onto which ink is to be jetted from the nozzle; and
while moving the print head carriage, jetting ink from the nozzle across the predetermined distance and onto the surface of the rigid panel.

6. The method of claim 5 wherein:
the surface of the panel onto which the ink is jetted varies across the panel in its distance from the carriage; and
the adjusting includes varying the position of the nozzle relative to the panel as the print head is moved to maintain the predetermined spacing between the nozzle and the location on the surface at which the ink is jetted.

7. The method of claim 6 further comprising the step of:
sensing the distance between the print head carriage and locations on the surface at which ink is to be jetted; and
varying the position of the nozzle relative to the print head carriage in response to the sensed distance.

8. The method of claim 6 further comprising the step of:
sensing the contour of the surface of the panel; and
moving the carriage parallel to the panel to locations determined in response to the sensed contour and jetting the ink onto the surface of the panel at said locations.

9. The method of claim 5 wherein:
the ink is UV curable ink;
the method further comprises the step of at least partially curing the ink jetted onto the surface by exposing the jetted ink to ultraviolet light.

10. An apparatus for printing on a surface of a three-dimensional substrate comprising:
a frame having a substrate support mounted thereon defining a substrate supporting plane and a print head track extending parallel to the plane;
at least one ink jet print head having at least one nozzle thereon and moveably supported on the track with the nozzle directed toward the surface of a substrate supported by the substrate support;
a sensor operable to determine a distance therefrom of a portion of the surface; and
the nozzle being moveable perpendicular to the plane in response to the sensor to a predetermined distance from the surface of the substrate; and
a controller operable to move and control the nozzle to print on the substrate by jetting ink from the nozzle across the predetermined distance and onto the surface of a substrate.

11. The apparatus of claim 10 further comprising:
a UV light curing head on the frame and positioned so as to expose ink jetted onto the surface of a substrate by the print head to UV light;
the UV light curing head is moveable perpendicular to the plane; and
the controller is operable to move the curing head to maintain focus of UV light from the print head on ink jetted onto the surface of the substrate.

12. The apparatus of claim 10 wherein:
the sensor is a non-contact, distance measuring device that includes a light source and light detector mounted on the track.

13. The apparatus of claim 10 wherein:
the sensor is a non-contact, distance measuring device that includes a light source and light detector mounted on the track; and
the track has further mounted thereon a servo motor responsive to an output signal from the sensor to adjust the position of the nozzle.

14. The apparatus of claim 10 wherein:
the sensor includes moveable mechanical elements that maintain contact with the surface of the substrate; and
the nozzle is linked to the mechanical elements so as to move in response thereto.

15. A system for printing images on a substrate, comprising:
a multiplicity of print heads mounted in a carriage, the print heads being positioned a distance from the substrate;
a sensor which detects the thickness of the substrate; and
a control system which receives the substrate thickness information detected by the sensor and transmits signals to a motor coupled to the carriage, the transmitted signals instructing the motor to adjust the position of the carriage to maintain a desired gap between the print heads and the substrate.

16. The system of claim 15, wherein the control system includes a controller which transmits the signals to the motor.

17. The system of claim 16, wherein the controller is coupled to a CPU which receives a substrate thickness information signal from the sensor, processes the information, and transmits signals to the controller to instruct the motor to adjust the position of the carriage to maintain the desired gap.

18. The system of claim of claim 16, wherein the control system includes a feedback device which senses the gap between the print heads and the substrate, the gap information being relayed to the controller such that the controller can further instruct the motor to alter the position of the print heads relative to the substrate to achieve the desired gap.

19. The system of claim 18, wherein the feedback device transmits the gap information to a CPU which process the information and relays the processed gap information to the controller.

20. The system of claim 15, wherein the motor is a servo motor.

21. The system of claim 15, wherein the minimum gap is about 0.04 inch.

22. The system of claim 20, wherein the maximum gap is about 0.08 inch.

23. The system of claim 15, wherein upon the sensor detecting the thickness of the substrate, the position of the carriage is adjusted in less than about five seconds.

24. The system of claim 15, wherein the sensor includes an indicator roller.

25. The system of claim 24, wherein the sensor includes a dial indicator coupled to the indicator roller.

26. The system of any of claims 15 through 25 further comprising a table adapted to support the substrate, including flexible and non-flexible substrates.

27. The system of claim 26, wherein the sensor detects the thickness of the substrate as the substrate moves through the system.

28. The system of any of claims 15 through 25 wherein the sensor detects the thickness of the substrate as the substrate moves through the system.

29. The system of claim 15, wherein the difference between the minimum gap and maximum gap is at least about one millimeter (0.04 inch).

30. The system of claim 29 further comprising:
a table adapted to support the substrate, including flexible and non-flexible substrates.

31. The system of claim 15, wherein the sensor is mounted in the carriage.

32. The system of claim 15, wherein the sensor includes two sensors mounted in the carriage.

33. The system of claim 15, wherein:
the print heads are bidirectional print heads that print while moving transversely across a substrate that is moveable longitudinally relative to the print heads,
the sensor includes two sensors mounted in the carriage transversely of the print heads, one on each side of the print heads.

34. A method for controlling the distance between print heads of a printing system and a substrate, comprising:
moving the substrate relative to the print heads;
detecting the thickness of the substrate while the substrate moves relative to the print heads;
transmitting the thickness information to a controller;
transmitting height adjustment information signals from the controller to a motor coupled to a carriage which holds the print heads; and
adjusting the position of the carriage with the motor to maintain a desired gap between the print heads and the substrate.

35. The method of claim 34, further comprising detecting the distance between the print heads and the substrate.

36. The method of claim 35, further comprising transmitting the distance information to the controller and re-adjusting the position of the print heads based on the distance information detected.

37. The method of claim 34, wherein adjusting maintains the desired gap in the range from about 0.04 inch to about 0.08 inch.

38. The method of any of claims 34 through 37 further comprising:
positioning a substrate on a table adapted to support flexible and non-flexible substrates.

39. The method of claim 34, wherein adjusting maintains the desired gap over a range of at least about one millimeter (0.04 inch).

40. The method of claim 39 further comprising:
positioning a substrate on a table adapted to support flexible and non-flexible substrates.

41. The method of claim 34, wherein:
the moving of the substrate includes moving the substrate longitudinally relative to the printheads;
the method further comprises moving the print heads transversely on a carriage relative to the substrate; and
the transmitting of the thickness information includes transmitting the information from a sensor on the carriage.

42. The method of claim 41 wherein:
the transmitting of the thickness information includes transmitting the information from at least one of at least two sensors mounted on the carriage.

43. A method of printing on a plurality of substrates, including flexible and non-flexible substrates, comprising:
positioning a first substrate having a first thickness on a table, the first substrate comprising a first one of a flexible and non-flexible substrate;
moving the first substrate relative to the print heads;
detecting the thickness of the first substrate;
transmitting the thickness information to a controller;
transmitting height adjustment information signals from the controller to a motor coupled to a carriage which holds the print heads;
adjusting the position of the carriage with the motor to maintain a desired gap between the print heads and the substrate;
printing an image on the first substrate;
positioning a second substrate having a second thickness on the table, the second substrate comprising the second one of a flexible and non-flexible substrate;
moving the second substrate relative to the print heads;
detecting the thickness of the second substrate;
transmitting the thickness information to a controller;
transmitting height adjustment information signals from the controller to a motor coupled to a carriage which holds the print heads;
adjusting the position of the carriage with the motor to maintain a desired gap between the print heads and the second substrate, the gap substantially identical to the gap between the print heads and the first substrate; and
printing an image on the second substrate.

44. The method of claim 43, wherein the steps of detecting the thicknesses of the substrates, transmitting height adjustment signals, and adjusting the position of the carriage are performed automatically with substantially no user intervention.

45. The method of claim 43, wherein the steps of detecting the thicknesses of the substrates, transmitting height adjustment signals, and adjusting the position of the carriage are all performed within about 5 seconds or less.

46. The method of any of claims 43 through 45 wherein the plurality of substrates includes flexible and non-flexible substrates, and wherein the positioning of the first substrate comprises a first one of a flexible and non-flexible substrate and the positioning of the second substrate comprises the second one of a flexible and non-flexible substrate.

47. The method of claim 43, wherein:
the transmitting of the thickness information includes transmitting the information from at least one sensor mounted on the carriage.

48. The method of claim 47, wherein:
the moving of a substrate includes moving the substrate longitudinally relative to the print heads and moving the print heads transversely on a carriage relative to a substrate.

49. The method of claim 48 wherein:
the transmitting of the thickness information includes transmitting the information from at least one of at least two sensors mounted on the carriage.
